(19) United States
(12) Patent Application Publication
(10) Pub. No.: US 2003/0162577 A1
(43) Pub. Date: Aug. 28, 2003

(54) Poker--super stud, the game

(76) Inventor: Garry Hamud, Los Angeles, CA (US)

Correspondence Address: GARRY HAMUD, P O BOX 0937, Whittier, CA, 90608, US

(21) Appl. No.: 10/079,410

(22) Filed: Feb. 22, 2002

(51) Int. Cl. A63F 13/00

(52) U.S. Cl. 463/13

(57) ABSTRACT

A player, playing “player's hand only” format video poker machine deposits money into the machine as a wager to cause the machine to deal and display a video image of two five card stud poker hands from a standard deck of fifty-two cards, face up. The player may win on one or both hands per a pre-established poker hand ranking paytable, the amount won based the hand ranking and the amount wagered. If, however, the player has a threshold hand, be it only a pair in either or both hands, and nothing else, (as determined by the variation of the game played), then, the player is allowed to and does play all ten cards on the screen as a single, Super Stud hand, winning any of the pre-established poker hand rankings in the Super Stud paytable. In this game, the pair is the threshold hand. In other variations, it could be only some but not all pairs, and/or hands wherein there were no winners or pairs at all (losing hands).

| | |
|---|---|
| INVENTOR: | Hamud, Garry Allen |
| | PO Box 0937 |
| | Whittier, California USA 90608-0937 |

REFERENCES

| | |
|---|---|
| 4743022 | May, 1998 |
| 5725216 | March 1998 |
| 5816914 | October 1998 |
| 5816915 | October 1998 |
| 5823873 | October 1998 |
| 5882259 | March 1999 |
| 5851147 | December 1998 |
| 6019374 | February 2000 |
| 6206780 | March 2001 |

### BACKGROUND OF THE INVENTION

This invention has to do with and relates to the general field of casino gaming (wagering/betting), particularly to playing of a poker game, on a video poker machine.

Poker itself is one of the oldest and most popular card games in the United States, and poker has a gambling aspect to it that allows a player to wager that he or she holds a poker hand that is higher in rank than the hands held by other players in the same game.

Almost all poker games feature a five card hand, and the player holding the highest ranking hand is usually the declared winner. The usual and ordinary pre-established poker hand rankings, from high to low, are as follows:

ROYAL FLUSH, being Ace, King, Queen, Jack, and Ten of the same suit

STRAIGHT FLUSH, being any five cards in sequence of the same suit

FOUR OF A KIND, aces being highest

FULL HOUSE, being three of a kind and a pair

FLUSH, being five cards of the same suit

STRAIGHT, being five cards in sequence but all or some of different suits

THREE OF A KIND, being three cards of the same rank, like three aces

TWO PAIRS, being a set of two cards alike

ONE PAIR, being two cards of the same rank

NO PAIR.

A popular form of poker in today's casino environment is video poker, played on a video poker machine. Video poker machines are designed to replicate play of a hand of poker, and, in most all video poker, only one player plays at a given video poker machine.

In video poker, the player tries to achieve the highest possible poker hand with the cards dealt. In that the player is not playing against other players in conventional video poker, he or she actually plays the cards of each hand against a pre-established paytable. The higher the poker hand ranking achieved by the player, the more the player wins, per the payable, based upon the number of coins, tokens, or credits (money) wagered by the player.

Historically, the first electronic video poker machines were standard draw poker games that dealt a player the customary five card hand from a fifty-two card deck,

In draw poker, the player is dealt five cards, and the player selects one to five of the said cards to hold, discarding any unwanted cards, to be replaced from the deck. Winning or losing poker hands are determined by comparing the player's final hand to the pre-established poker hand paytable.

A very typical paytable for video poker is as follows:

TABLE ONE
Awards per One Coin Played

| | |
|---|---|
| Nada | 0 |
| One Pair | 1 |
| Two Pair | 2 |
| Three of a Kind | 3 |
| Straight | 4 |
| Flush | 6 |
| Four of a Kind | 25 |
| Straight Flush | 50 |
| Royal Flush | 250 |

Variations of this form of video poker, be it stud or draw, include the use of wild cards, such as Deuces Wild, and/or the use of Jokers, whereby one or two Jokers are added to the standard deck. Jokers are usually “wild” in hands with aces, straights, or flushes.

Recently, multiple hand draw poker has developed in the video poker format. One game is known as “Double Poker,” described in U.S. Pat. No. 5,356,140. Double Poker is essentially the same as draw poker, except that the player, for a single wager, is dealt two, five card hands from two separate decks of cards, whereupon he or she gets to select which of the hands to play for the bet he has wagered.

Another form of this multiple approach to video poker is “Pick One Poker,” described in U.S. Pat. No, 5,816,915. This game deals the player four, separate five card hands of poker from a single deck after the player has placed his wager, and, then, the player selects which one of the five hands to play as his or her own.

A most popular version of multiple video poker is “Triple Play Poker,” described in U.S. Pat. No, 5,823,873. In this game of poker, the player places a separate bet on each of three hands. The first hand is dealt, and the player, then, has selects none, one, two, three, four, or five thereof to hold, discarding the rest. The selected cards are, then, duplicated into two other hands of poker. Replacement cards are dealt for the non-selected cards into the first hand. And, remaining, additional cards are dealt into the other two hands, so all three hands have five cards in each. The player is then paid any winnings for any of the winning poker hands based upon the pre-established poker paytable.

It should be noted at this point that in U.S. Pat. No. 6,132,311, the multi-bet requirement in this latter form of poker, albeit the most popular in present day casinos, was depicted as a drawback to the game.

including the fact that forty-two (42%) percent of all winning hands are nothing more than even money awards, and, more importantly, no large or progressive jackpot of any real size can be offered. And, in all

Other types of player's hand only video poker have evolved, including some forms of what is commonly known as stud poker, both five and seven card stud.

In the electronic version of seven card stud poker, the player is asked to wager before being dealt three cards, whereupon, he or she has the option of folding, in which case, the wager is lost, or, in the alternative, the player may go forward and place an additional wager and, then, receive four more cards, for a total of seven. The player will in the end wins or loses the hand based upon the customary pre-established poker hand ranking paytable for the best five card hand out of the seven.

In a different version of electronic stud poker, being five card stud, the player wagers before being dealt four cards. The player, then, has the option of folding or placing an additional wager in order to receive the fifth and final card. The value of the player's hand is, again, determined by a customary poker hand ranking paytable. This sort of game is further described in U.S. Pat. No. 5,167,413.

There are real, intrinsic drawbacks in any and all of the aforesaid draw and stud “player's hand only” poker games that are a function of fact that in any such setting, there is only one player at each video machine, playing poker, against a conventional poker paytable. The result, of course, is that in nearly all such games, including the games mentioned in the above, forty two (42%) percent (+/−) of all “winners” are nothing more than even money pay, and, more importantly, none of the winners are, by today's standards, big winners. Even when these games are linked in multi-machine networks, the largest jackpots are still small. The reason for this is, again, the fact that there are only 2,598,960 possible hands in such draw or stud poker, so the type of probabilities that allow for mega-jackpots are absent from the game.

It is an object of the present invention to do more with poker in this video format and to, thereby, provide a poker game that captivates the interest of a casino patron with a simple, understandable, and interesting game that is also exciting and rewarding to play, that is not “just a cash register,” all too often only giving small change back to player, and that actually can offer to the playing public large jackpots of up to and over 1,000,000 times/bet.

Other features, advantages, and related objects of the present invention will become apparent from a consideration of the details presented herein.

### SUMMARY OF THE INVENTION

The object and purpose of the present invention is to provide a poker game also suitable for video poker that captivates the interest of a gaming/casino patron. In order to do this, the game must be simple, understandable, interesting, and rewarding, hence the invention of Super Stud.

This invention has to do with and relates to the general field of casino gaming (wagering/gambling), and more particularly to playing of a poker game on an electronic video poker machine.

In this invention, referred to as “Super Stud,” the poker game deals two five card hands of what is generally known as stud poker, all from a standard deck of fifty-two playing cards, face up to the player. The player, prior to the dealing of the cards, places his or her wager or bet on the “hand” to be dealt. As more fully described herein, the player's wager is equally divided between the two five card hands, or, for simplicity, the player can place a separate but equal bet on both hands, with the same result.

The player may win on one or both of the five card hands that has a pre-established poker hand ranking in the Super Stud paytable. The amount won by the player is based on the five card poker hand ranking of each hand and the amount wagered by the player.

If the player has no winning hands, per the poker hand ranking in the Super Stud payable, the game is over.

If the player, however, has at least one pair in either or both of the said five card hands dealt, and nothing else, then, the player is allowed to play, and does play, all ten cards, as a single, Super Stud hand, and the player may, then, win any of the pre-established poker hand rankings in the Super Stud paytable. In this game, the single pair of cards is the threshold to playing the Super Stud hand.

In a variation of the present invention, only designated pairs, such as a pair of deuces, threes, fours, fives, sixes, sevens, eights, nines, and tens, but not jacks or better—jacks, queens, kings, and aces, would allow the player to play the ten card hand. In this game, designated pairs of cards would be the threshold to playing Super Stud, and other non-designated pairs would be included in the payable as a pre-established winning hand, or, in the alternative, not be so included in the paytable.

In a different variation of the present invention, any or all of the possible pair hands that can be dealt to a player can be considered winning hands once they are added to the payable, and, the pair presence in a designated hand would not allow the player to jump to the ten card hand. Rather, the player, in this variation, would be allowed to play the ten card hand, meaning he or she would play Super Stud, only when the player was dealt no winning hand whatsoever in both of the original five card hands as determined by the paytable. In this variation, then, a losing hand is the threshold to playing the Super Stud hand.

For simplicity purposes, all of the above-mentioned variations use a similar paytable that awards recognized, pre-established, five card poker hand rankings as winners, with one exception: the Royal Flush, which is in the paytable as the highest ranked winning hand in the standard five card version and, also, six, seven, eight, nine, and ten card versions too.

In a supplement to any of the above variations, a Straight of more than five cards, say, six, seven, eight, nine, or ten cards, can be added to the pre-established poker hand rankings for winning hands. The same is true of the Flush of more than five cards, say, six, seven, eight, nine, or ten cards, can be added to the pre-established poker hand rankings for winning hands.

In a supplement to any of the above variations, wild cards, such as deuces wild, and or Jokers, one or two, can be added to the game. Jokers would be wild in hands with aces, straights, and flushes, however Jokers, in the alternative, could be made wild in any hand. The addition of wild cards adds a new five of a kind winner to the paytable, and, in addition, increase win frequency.

Paytable awards to such pre-established poker hand rankings in this game range from small and routine to very, very large.

### DETAILED DESCRIPTION OF THE PREFERRED EMBODIMENTS

Preface

While the method of the present invention is herein described in connection with an electronic video poker machine, the method of play may also be practiced in a live gaming table format, with a live dealer or, for that matter, in a live table format, with electronic deal. Also, the method of the present invention may be practiced in a non-wagering or tournament format wherein points are used instead of items of monetary value. And, the method of the present invention can be practiced in an interactive format such as is as used on the Internet.

Further, the present invention, along with specific embodiments thereof, as depicted herein, should be considered as illustrative rather than limiting in that various modifications and additions may be made and are already apparent to others with skills in the art, meaning that the invention should not be limited by the this description.

Description of Embodiments

As is depicted in FIG. 2, a video poker machine(FIG. 2, 1) includes a coin slot (FIG. 2, 4) wherein a player deposits money in the form of coin and a bill acceptor (FIG. 2,5) for currency. The machine also includes a video unit viewing surface (FIG. 2, 3) on the face (FIG. 2, 2) of the machine.

The machine also includes a control panel (FIG. 2, 6) with a deal/draw button (FIG. 2, 7) and, in the case of this invention, as Play Super Stud button (FIG. 2, 8). The Super Stud button also doubles as the bet button (FIG. 2, 12).

Near the base (FIG. 2,10) of the machine, there is a tray (FIG. 2, 9) for coins disgorged by the machine to the player.

After placing a wager by depositing money into the machine per the above, if not otherwise set on automatic, the player depresses the bet button (FIG. 2, 12 or FIG. 3, 15) to place a wager while the video display FIG. 3 displays to the player ten face down cards (FIG. 3, 1-10). When the player next presses the deal/draw button (FIG. 2, 7 or FIG. 3, 16), the video displays an image of ten playing cards (FIG. 4, 1-10) face up on the video unit viewing surface (FIG. 2,3).

In FIG. 4, there is presented a schematic representation of a sample display of an electronic video poker gaming machine used in the practice of this invention. This representation shows the preferred location in which to display the cards dealt to a player (FIG. 4, 1-10), along with the screen display of the applicable paytable (FIG. 4, 13), player's bet (FIG. 4, 12), and player's total credit (bankroll)(FIG. 4, 11).

The screen display represented in FIG. 4 shows that it provides for various touch screen feature locations that use conventional touch screen technology to allow the player to conduct the method of play of the present invention. For example, the Coin Out button (FIG. 4, 17) appears in the lower right hand corner of the video display and, when touched, allows the player to collect all player credits from the machine from the machine's tray (FIG. 2, 9).

It should be understood that the aforesaid ten face up cards (FIG. 4, 1-10) are randomly selected from the deck of cards used in the game, being as follows:

(top hand)

the nine of spades, the nine of clubs, the nine of diamonds, the four of clubs, the four of spades

(bottom hand)

the jack of spades, the king of clubs, the queen of hearts, the ace of clubs, and the three of hearts.

These cards make up two, five card poker hands, and, together, one ten card hand of super stud (FIG. 4, 1-10, FIG. 5, 1-10).

The cards displayed (FIG. 4, 1-10) are evenly spaced, with edges collinearly aligned, parallel to their edges.

The cards displayed (FIG. 4, 1-10), for demonstration purposes, thus, reflect, in the top hand, a full house and, in the bottom hand, a pair (See FIG. 5).

Had the player been dealt the ten cards (FIG. 4, 1-10) without any ranked winning hand as pre-established by the applicable poker hand ranking paytable (FIG. 8), the game would be over within the first method of play that uses a pair, and only a pair to proceed. (More below)

Likewise, if the player had been dealt what is depicted on the screen display (FIG. 4, 1-10), the game would likewise be over, however, as is reflected in the paytable (FIG. 4, 13), the player would have been awarded 9 credits for the winning full house hand of cards (FIG. 4, 6-10).

Had the player received only the pair (FIG. 4, 1-5) as depicted in the display (FIG. 4), and only the pair, then, the player would have the opportunity to play, and would play, all ten cards, as single, super stud hand (FIG. 4, 1-10), and, then, the player could be eligible to win any of the pre-established poker hand rankings in the super stud paytable, per FIG. 8. The player would actuate this function by pressing the play super stud button (FIG. 2, 12) on the control panel or the touch screen version of the same on the video screen (FIG. 4), not shown.

Once the player has pressed the super stud button (FIG. 2, 12), the player would receive a payout for any winning five card poker hand (FIG. 4, 1-5 and FIG. 4, 6-10) ranking within and among the ten face up cards (FIG. 4, 1-10) as well as any other six, seven, eight, nine, or ten card super stud hand, per the pre-established game paytable, an example of which is set forth in FIG. 8. These winnings, like any other winnings herein, would be disgorged by the machine into its coin tray (FIG. 2, 9) or, per the player's preference, credited to his total credits and reflected on the screen in the total credit location (FIG. 4, 11). Large jackpots would in the usual course be paid in cash (not shown).

In one alternative embodiment of this invention, the player's opportunity to play the ten card (FIG. 4, 1-10) super stud hand would be accessed upon the appearance of some but no any and all pairs. For example, a pair of jacks or better, or, in the alternative, a pair of cards less than jacks or better, would be required in order to proceed the ten card hand.

In a different ad alternative embodiment of this invention, the player's opportunity to play the ten card hand (FIG. 4, 1-10) would be accessed only upon the player being dealt only losing hands, in both five card hands, meaning there would be an absence of any winning hand or pairs from both hands.

Also, another variant of this embodiment of this invention is the inclusive of one or more wild cards and 0.1 or the placement of one or two Jokers into the deck. Such an addition would add to the pre-established paytable Five of a Kind winners, and, in addition, increase overall winning combinations.

In a variant of this embodiment of this invention, it is possible to deal from two separate decks to the player.

And, another variant of this embodiment of this invention is the inclusive of one or more wild cards and/or the placement of one or two Jokers into the deck, with the same results, per the above.

In any of the above embodiments of this invention, and depending upon the rules of various gaming jurisdictions, any of the top paying jackpot awards in a pre-established poker hand ranking paytable can be grouped together to thereby reduce the otherwise long odds of winning the same (FIG. 8, Sample paytable).

Likewise, within the aforesaid pre-established poker hand ranking paytable, five card winning poker hand rankings can be supplemented with various six, seven, eight, nine, and ten card winning poker hand rankings (FIG. 8), especially, for straights and flushes (FIG. 7) (FIG. 8).

Once game play is complete in any of the above embodiments, the game is indicated as over, and the player is prompted to begin a new hand of play by placing his bet (FIG. 5, 1 and 2).

### BRIEF DESCRIPTION OF THE DRAWINGS

FIG. 1.: Plan view of a video poker machine, overall aspect

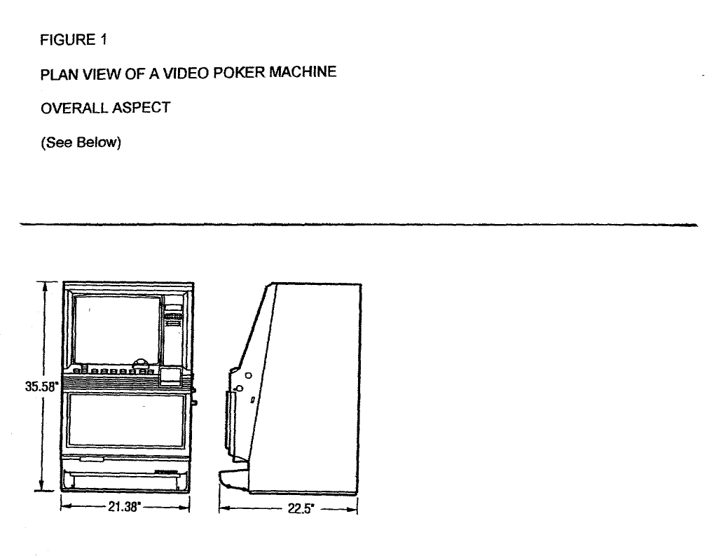

FIG. 2: Plan view of a video poker machine, with details

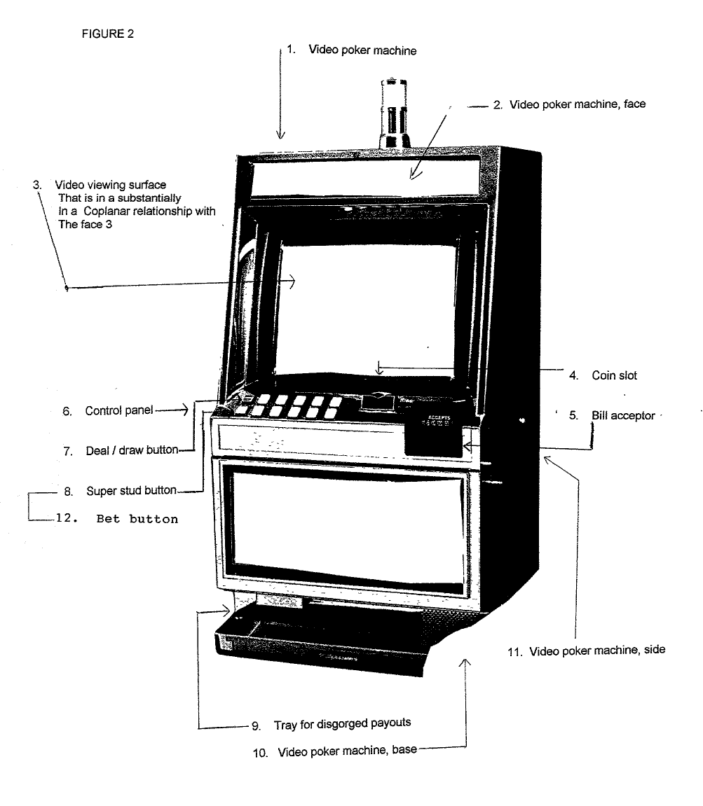

FIG. 3 Plan view of video poker machine screen display of ten “super stud” cards face down, with sample screen details

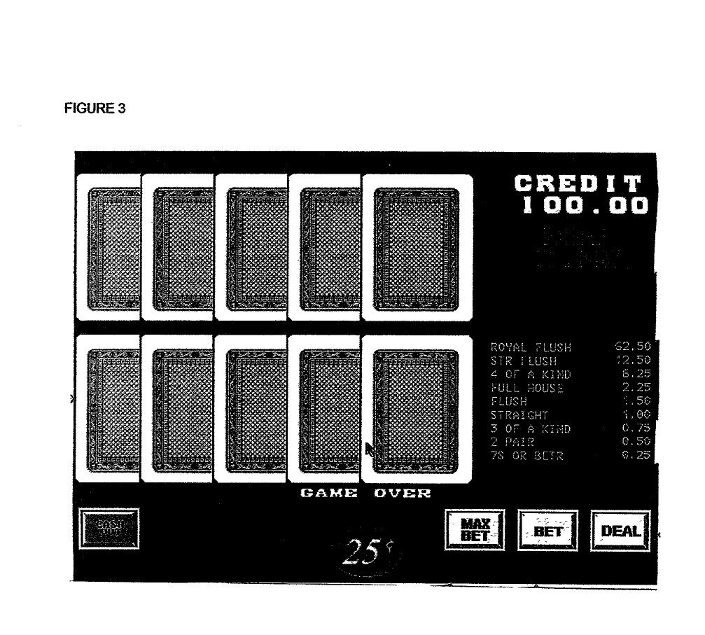

FIG. 4 Plan view of video poker machine screen display of ten “super stud” cards face up, with sample screen details

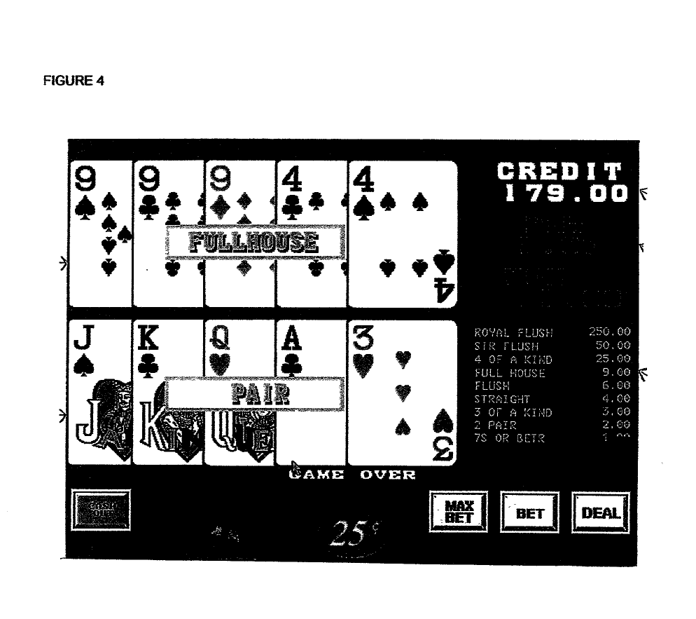

FIG. 5 Plan view of video poker machine screen display of ten “super stud” cards face up, with sample screen details, including Sample declared winner

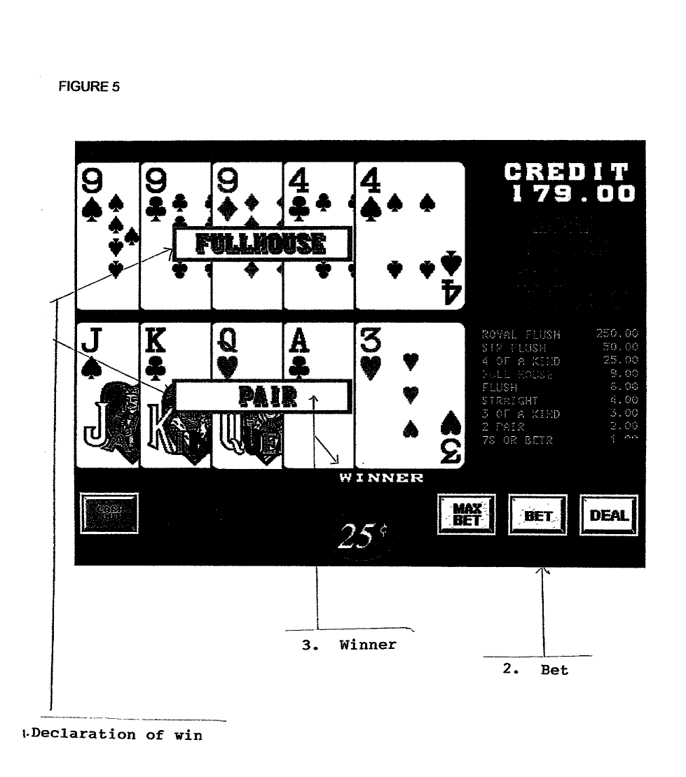

FIG. 6: Five car stud percentage sheet

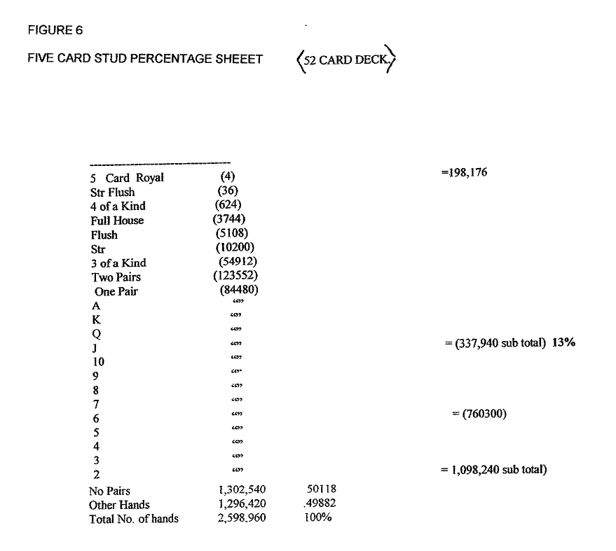

FIG. 7 Sample Five card stud percentage sheet, with additional card

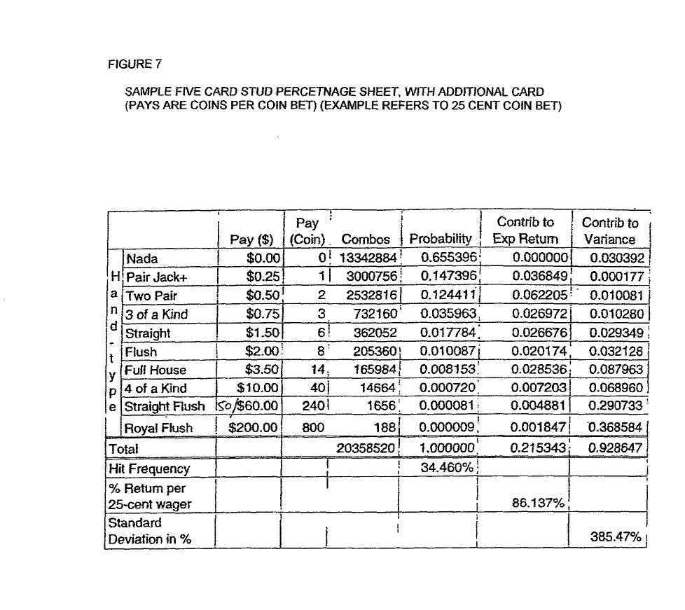

FIG. 8 Super Stud paytable, sample

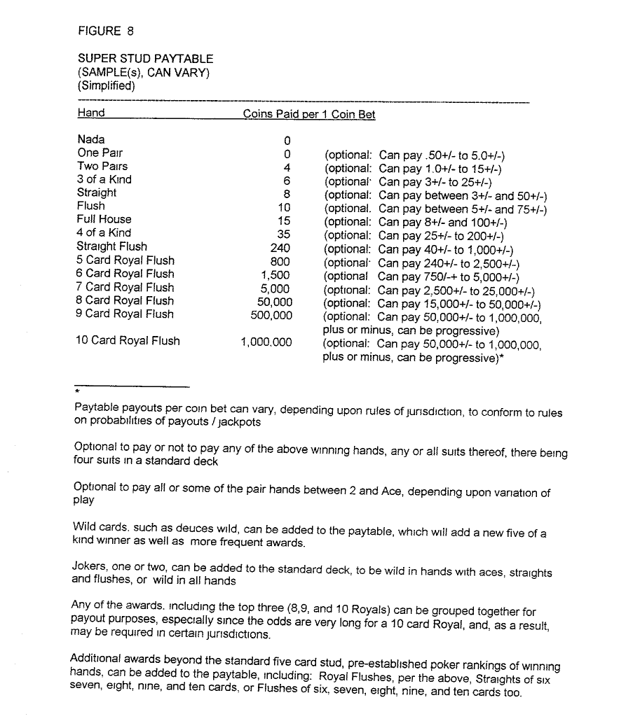

What is claimed:

I claim:

1. A method of playing a poker game using a deck of cards comprising the following steps:
a) a player making a wager, being one wager, to be equally allocated between the two five card hands, for a total of ten cards, to follow, or being two separate but equal bets, one on each of the said five card hands, for the same result,
b) providing a video display of the deal of an image of the ten cards, being two, five card hands, face up on the screen, that have been randomly selected from a standard deck of playing cards
c) making a five card stud payout to the player on either or both of the said five card stud hands when the five cards reflect a winning five card stud poker hand ranking, per the pre-established poker hand ranking paytable,
d) giving the player the opportunity of playing all ten cards as a single, super stud hand in the event the player has only a pair, and nothing more, in either or both of the five card hands, the pair, any pair, being the threshold to the ten card super stud hand,
e) making a payout to the player for any winning five card poker hand ranking within and among the ten cards as well as other six, seven, eight, nine, or ten card poker hand rankings, per the pre-established super stud poker hand ranking paytable,

2. The method of claim 1 wherein some but not all pairs provide to the player the opportunity of playing all the said ten cards as a single, super stud hand, per the above,

3. The method of claim 1 wherein the presence of a pair in either or both five card hands does not provide to the player the opportunity of playing all the said ten cards, and, instead, the absence of any winning hands and pairs from both five card hands provide the opportunity of playing all of the said ten cards as a single, super stud hand, per the above, losing hands being the threshold to the ten card super stud hand,

4. The method of claim 1 wherein, one or more cards, such as a deuces, are declared to play wild in the hands dealt, meaning they can play as themselves or any other card in the deck,

5. The method of claim 1 wherein one or two Jokers may be added to the deck(s), with the jokers to play as wild in hands including aces, straights, or flushes, and/or in any hand configuration at all,

6. The method of claim 1 wherein not one but two decks of playing cards are used in play.

7. The method of claim 6 wherein, one or more cards, such as a deuces, are declared to play wild in the hands dealt, meaning they can play as themselves or any other card in the deck,

8. The method of claim 6 wherein one or two Jokers may be added to the deck(s), with the jokers to play as wild in hands including aces, straights, or flushes, and/or in any hand configuration at all,
